(19) United States
(12) Patent Application Publication
(10) Pub. No.: US 2010/0192742 A1
(43) Pub. Date: Aug. 5, 2010

(54) STRIPPING APPARATUS

(75) Inventors: Steven W. Schroder, Grand Rapids, MI (US); Paul R. Slagboom, Nunica, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Michigan Lasercut

(21) Appl. No.: 12/696,681

(22) Filed: Jan. 29, 2010

Related U.S. Application Data
(60) Provisional application No. 61/148,604, filed on Jan. 30, 2009.

(51) Int. Cl. B26D 7/18; B23P 11/00

(52) U.S. Cl. 83/111; 29/428

(57) ABSTRACT

A broadhead stripping apparatus for ejecting waste material in a die converting process and a method of making the same is described wherein the broadhead stripping apparatus includes a broadhead stripping mechanism comprising a housing, a housing cover, a retractable stripping blade and a biasing mechanism. The broadhead stripping apparatus can be slidably mounted along a die press mount and the broadhead stripping mechanism can be fixedly of slidably mounted to the broadhead stripping apparatus allowing for fine tune adjustment for of the broadhead stripping apparatus or broadhead stripping mechanism in operation.

### CROSS REFERENCE TO RELATED APPLICATIONS

This application claims priority under 35 U.S.C. §119(e) and the benefit of U.S. Provisional Patent Application No. 61/148,604 filed on Jan. 30, 2009, entitled STRIPPING APPARATUS, the entire disclosure of which is hereby incorporated by reference in its entirety.

### TECHNICAL FIELD

The present invention generally relates to a stripping apparatus, and more particularly, to a stripping apparatus for removing waste pieces or pre-cut pieces of scrap from selected areas of sheets of various material utilized during the formation of blanks used to make various die converted structures.

### BACKGROUND OF THE INVENTION

It is noted that the die converting process is a suitable process for a variety of substrates including but not limited to plastic, paperboard, and Mylar. However, for purposes of this application, the paperboard converting process will be used as an example.

Generally, in the paperboard industry, paperboard blanks are manufactured from solid paperboards which are customized to create paperboard blanks from which folding cartons or wrap around cartons and carriers can later be created. During manufacture of these cartons and carriers, it is desired to deal with large paperboard sheets carrying a number of blanks rather than separating the blanks from one another as the paperboard moves along the die converting process. Thus, as paperboards move through the die cutting stage, cuts are made that almost pass all the way through the paperboard leaving cut out portions in the paperboard which will later become pieces of scrap when the paperboard is brought to a stripping stage of manufacture.

The stripping stage is where the paperboards are converted into individual blanks by removing the pieces of scrap from the selected areas of the paperboards. In the creation of carton blanks, high volume and increased efficiency are always of concern. The manufacture in feeding and folding of the carton blanks must be achieved at very high speeds in order to be practical. Thus, the apparatus used for stripping the pre-cut paperboard sheets must be able to function at a high rate of speed and continue to function for a relatively long period of time with little adjustment. A stripping apparatus that becomes continually obstructed with the pieces being stripped, or needs constant adjustment creates significant obstacles in the manufacture of carton blanks. The close proximity and size of waste being removed can affect the proper functioning of a stripping apparatus. To unclog or adjust a stripping apparatus as they are placed in the manufacturing process requires stopping the entire line, adjusting to the press as necessary, unclogging the stripping apparatus, removing any scrap material from the machine and adjusting the stripping apparatus as appropriate. Thus, durable and low maintenance stripping apparatuses are necessary to avoid these obstacles.

Formerly, in the stripping stage of manufacture, a pair of cooperating articles referred to as stripping pins, are mounted respectively above and below a stripper table. The waste material is then stripped when, by means of a known mechanism, upper and lower oppositely directed pairs of stripper pins are moved into simultaneous engagement with the waste portions of the paperboard sheets from above and below the paperboard sheet such that the stripper pins pinch the scrap section between the upper face of the lower pin and the lower face of the lower pin. Thus, the stripper pins, acting in tandem, undergo a downward movement which serves to pull the waste pieces from the paperboard sheets. After the scrap pieces are removed from the blank the upper and lower pins are withdrawn to their initial positions while the paperboard sheet is removed from the stripper table and another sheet is inserted and properly positioned for stripping. Formerly, in the stripping stage of manufacture, the stripping pins had to be mounted in very close relation in order to eject waste pieces from the paperboard sheets that were broader than the cross-section of the stripping pin head. This close grouping of stripping pins greatly increases the chances that one of the plurality of stripping pins will come out of alignment and need adjustment. Such an adjustment would be one which would require off-press make ready and necessitate the complete shutdown of the die converting line. Further, the grouping of stripping pins at the stripping stage left for free spaces between the stripping pins which were grouped to eject waste pieces that were broader than the cross-section of the stripping pin head. Given the rate at which the paperboard sheets are stripped in the stripping process, the resulting waste pieces that are ejected would commonly clog the stripping apparatus in the free space created by the stripping pin grouping. A clog of this nature eventually leads to the need to unclog the stripping apparatus which again is the result of off-press make ready calling for the complete shutdown of the die converting line.

A stripping device must be adjustable in many ways such that as a new carton blank is fed to the stripping table, stripping pins can be adjusted to line up with the associated waste pieces which will need to be removed. Thus, as the vertical motion of the press remains the same for each paperboard carton blank that is run through the press, the stripping devices must be adjusted on a “make ready” table or directly on the press where the upper and lower portions of the stripping device can be adjusted to coincide when the stripping mechanism is actuated. Therefore, it is important to use stripping devices which support rapid removal and replacement in the stripping unit to facilitate off-press or on-press make ready and thereby minimize downtime between jobs. Therefore, it is also important to use stripping devices which incorporate stripping heads or stripping blades which better correspond to the shape of the waste piece needed to be ejected to avoid the adjustment problems and clogging problems currently experienced with a stripping pin grouping.

### SUMMARY OF THE INVENTION

According to the present invention, an improved stripping apparatus is provided. One aspect of the present invention is a broadhead stripping mechanism for stripping waste material in the stripping stage of a die conversion process having a housing and a housing cover which are operably coupled together such that at least a portion of the housing and housing cover define a housing cavity by the above noted coupling. The housing cavity includes both a deep portion and shallow portion in configuration. A stripping blade is operably coupled to the housing and configured to be at least partially retractably received within the housing cavity. The stripping blade has a retracted position and an extended position wherein the stripping blade retracts partially into the housing cavity when in the retracted position. The stripping blade further includes a first end, a second end and a body portion wherein the first end comprises a catch which abuts the shallow portion of the housing cavity when the stripping blade is in the extended position and the second end comprises a stripping surface. A biasing mechanism is operably connected to the stripping blade and configured to bias the stripping blade towards the extended position.

Another aspect of the present invention is a stripping apparatus for stripping waste material in the stripping stage of a die conversion process having an upper portion and a lower portion mutually opposed in relation. The upper portion further includes a mounting bracket, a mounting bar that is operably coupled to the at least one mounting bracket, and at least one fixed broadhead stripping head that is operably coupled to the mounting bar. The lower portion further includes a mounting bracket, a mounting bar that is operably coupled to the at least one mounting bracket, and at least one broadhead stripping mechanism that is operably coupled to the mounting bar having a broadhead stripping blade.

Yet another aspect of the present invention is a method of making a stripping apparatus including the steps of providing a first mounting bracket, providing a first mounting bar adapted to slidably receive the first mounting bracket, coupling the first mounting bar to at least one fixed broadhead stripping head, providing a second mounting bracket, providing a second mounting bar adapted to slidably receive the second mounting bracket, coupling the second mounting bar to at least one broadhead stripping mechanism.

The stripping apparatus is designed to engage a series of bars and brackets and other mounting systems found in a die press such that the stripping apparatus will mount to a die press known in the art. The stripping apparatus, as attached to a die press, is used to pinch and separate waste pieces of paperboard from paperboard sheets (or waste sections from other materials suitable for use in a die converting process) as they travel in unison through the stripping portion of a carton blank making process. As the paperboard sheets move through the stripping portion of the die cutting process, fixed stripping heads and stripping mechanisms of the stripping apparatus are aligned on both the upper and lower portions of the stripping apparatus in mutually opposed relation such that when the die press is actuated the stripping surface of the fixed stripping heads and the stripping mechanisms will pinch the paperboard sheets as the paperboard sheets pass through the stripping nip. The stripping apparatus has both fixed stripping heads and retractable stripping mechanisms such that the fixed stripping heads will depress the retractable stripping mechanisms to positively eject waste pieces from the paperboard sheets. The stripping apparatus of the present invention is designed to be quickly installed and removed as necessary to improve down-time between jobs. The stripping apparatus of the present invention is also adapted to facilitate more precise stripping of waste pieces from the paperboard sheets as the paperboard sheets are moved through the carton blank manufacturing process.

The stripping apparatus of the present invention uses universal mounting supports that provide multiple positions for fine tune adjustment of the stripping apparatus on the die press. The fixed and retractable stripping heads (or blades) are interchangeable such that various profiles of the stripping head can be used to more closely resemble the waste area to be removed.

These and other features, advantages, and objects of the present invention will be further understood and appreciated by those skilled in the art by reference to the following specification, claims and appended drawings.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a fragmentary perspective view of a stripping apparatus embodying the present invention;

FIG. 2 is a fragmentary perspective view of another embodiment of the present invention;

FIG. 3 is a fragmentary exploded perspective view of the present invention;

FIG. 4 is a fragmentary exploded perspective view of an upper portion of the stripping apparatus;

FIGS. 5A-5C are perspective views of various stripping blades of the stripping apparatus;

FIG. 6 is a left-hand side elevational view of a part of the lower portion of the stripping apparatus;

FIG. 7 is a fragmentary front elevational view of a part of the lower portion of the stripping apparatus;

FIG. 8 is a right-hand side elevational view of a part of the lower portion of the stripping apparatus;

FIG. 9 is a cross-sectional view of a part of the lower portion of the stripping apparatus taken along the line IX, FIG. 7;

FIG. 10 is a cross-sectional view of a part of the lower portion of the stripping apparatus taken along the line X, FIG. 7;

FIG. 11 is a fragmentary top plan view of a part of the lower portion of the stripping apparatus;

FIG. 12 is a fragmentary exploded perspective view of yet another embodiment of the present invention;

FIG. 13 is a fragmentary perspective view of the lower portion of the stripping apparatus;

FIG. 13A is a fragmentary perspective view of the lower portion of the stripping apparatus;

FIG. 14 is a fragmentary perspective view of a part of yet another embodiment of the present invention;

FIG. 15 is a left-hand side elevational view of the lower portion of another embodiment of the stripping apparatus;

FIG. 16 is a fragmentary front elevational and partial cross-sectional view of a part of the lower portion of another embodiment of the stripping apparatus;

FIG. 17 is a right-hand elevational and partial cross-sectional view of a part of the lower portion of another embodiment of the present invention;

FIG. 18 is a cross-sectional view of a part of the lower portion of the stripping apparatus taken at line XVIII, FIG. 16;

FIG. 19 is a cross-sectional view of a part of the lower portion of the stripping apparatus taken along the line XIX, FIG. 16; and

FIG. 20 is a fragmentary bottom plan view of a part of the lower portion of the stripping apparatus.

### DETAILED DESCRIPTION OF THE PREFERRED EMBODIMENT

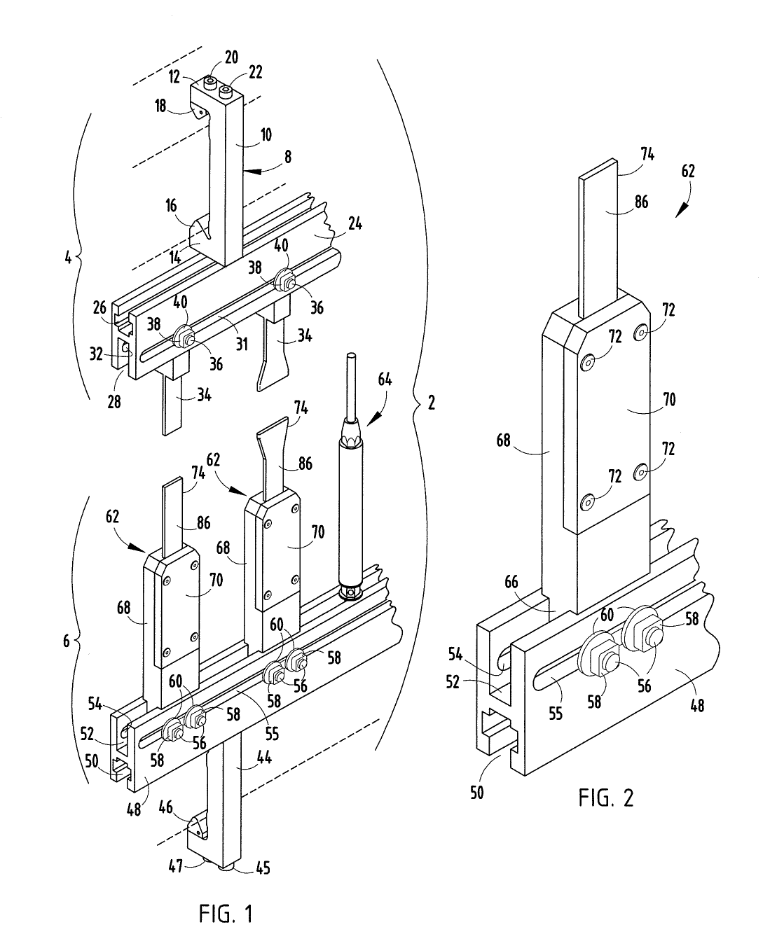

For the purposes of description herein, the terms “upper,” “lower,” “right,” “left,” “rear,” “front,” “vertical,” “horizontal,” “top,” “bottom” and derivates thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification, are simply exemplary embodiments. Hence, specific dimensions and other physical characteristics relating to the embodiments disclosed herein are not to be construed as limiting, unless expressly stated otherwise. It is noted that the die converting process is a suitable process for a variety of substrates including but not limited to plastic, paperboard, and Mylar. However, for purposes of this application, the paperboard converting process will be used as an example.

With reference now to the drawings, in particular FIG. 1, a stripping apparatus 2 embodying the present invention is illustrated comprising an upper portion 4 and a lower portion 6. The upper portion 4 comprises a U-shaped upper mounting bracket 8 having a body portion 10, an upper arm 12, and a lower arm 14. The lower arm 14 of the U-shaped upper mounting bracket 8 comprises a fixed wedge 16 as shown in FIG. 1. The upper arm 12 of the U-shaped upper mounting bracket 8 comprises an adjustable wedge 18 as well as an adjustment driver 20 disposed on the top part of the upper arm 12. In operation, the U-shaped upper mounting bracket 8 uses the fixed wedge 16 and adjustable wedge 18 of the upper and lower arms 12, 14 to clamp onto a mounting system (indicated by the dashed lines in FIG. 1) as found on a die press assembly (not shown). The fixed wedge 16 and adjustable wedge 18 fit into grooves on the mounting system of the press and the adjustment driver 20 is then used to vertically manipulate the adjustable wedge 18 to frictionally fit the U-shaped upper mounting bracket 8 on the mounting system of the press. The adjustment driver 20 can be loosened such that the U-shaped upper mounting bracket 8 is not fully dislodged from the mounting system of the press, but is slidably engaged within the grooves of the mounting system of the die press for infinite adjustment of the upper portion 4 of the stripping apparatus 2.

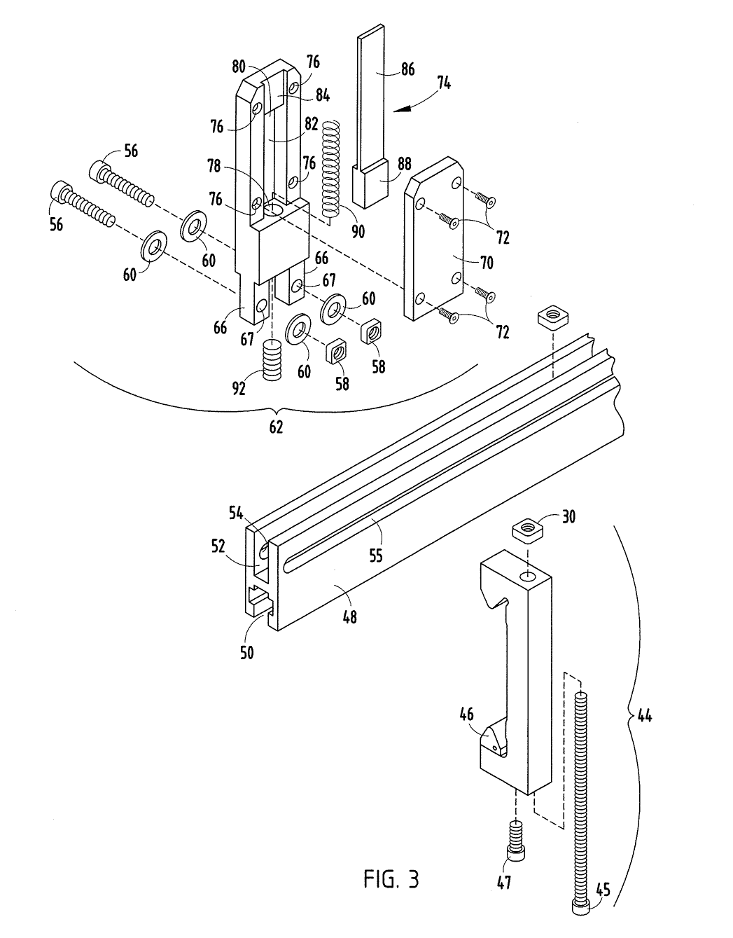

The U-shaped upper mounting bracket 8 further comprises a tensioning bolt 22 which is used for attaching the U-shaped upper mounting bracket 8 to an upper mounting bar 24. The upper mounting bar 24 comprises an inverted T-shaped channel 26 disposed on the top portion of the upper mounting bar 24 and an inverted U-shaped channel 28 disposed on the bottom portion of the upper mounting bar 24. In this embodiment, the inverted T-shaped channel 26 and the inverted U-shaped channel 28 run the length of the upper mounting bar 24. The U-shaped upper mounting bracket 8 engages the inverted T-shaped channel 26 of the upper mounting bar 24 using a mounting block 30 (FIG. 3), which is disposed within the inverted T-shaped channel 26. The mounting block then engages the tensioning bolt 22 of the U-shaped upper mounting bracket 8 to hold the U-shaped upper mounting bracket 8 frictionally in place on the top portion of the upper mounting bar 24. The inverted T-shaped channel 26 is laterally disposed along the length of the top portion of the upper mounting bar 24 such that the U-shaped upper mounting bracket 8 and the upper mounting bar 24 are slidably engaged with one another, such that the U-shaped upper mounting bracket 8 can be adjusted to an infinite number of positions along the inverted T-shaped channel 26 of the upper mounting bar 24.

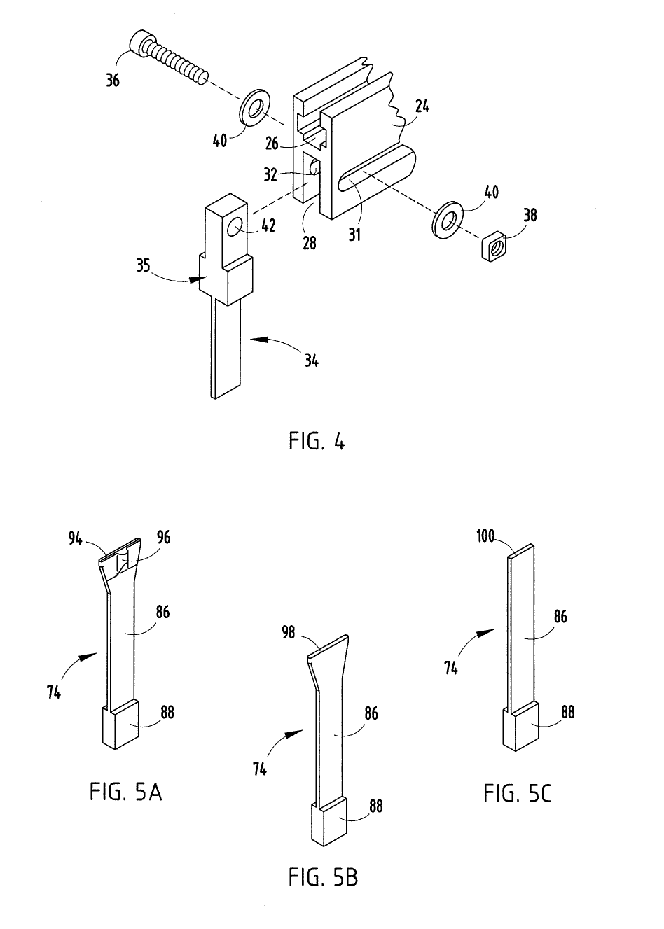

The inverted U-shaped channel 28 of the upper mounting bar 24 further comprises oblong shaped apertures 31, 32 disposed on the front and back side of the upper mounting bar 24 which run substantially the length of the upper mounting bar 24. The inverted U-shaped channel 28 is used to house fixed stripping heads 34 which, in this embodiment, are connected with a tensioning bolt 36 which engages a mounting nut 38 and washers 40 after passing through the oblong shaped apertures 31, 32. Tensioning bolts 36 also pass through the inverted U-shaped channel 28 and further pass through the body portion 35 of the fixed stripping heads 34, through the aperture 42 as shown in more detail in FIG. 4. In this way, the fixed stripping heads 34 are slidably engaged with the upper mounting bar 24 allowing for an infinite amount of adjustments of the fixed stripping heads 34 along the upper mounting bar 24.

The lower portion 6 of the stripping apparatus 2 comprises a U-shaped lower mounting bracket 44 which further comprises an adjustable wedge 46 for use in slidably connecting the U-shaped lower mounting bracket 44 to a die press in similar fashion to the mounting of the U-shaped mounting bracket 8 of the upper portion 4. The lower portion 6 further comprises a lower mounting bar 48 having a T-shaped channel 50 and a U-shaped channel 52 similar to the upper mounting bar 24 but inverted in orientation. The lower mounting bar 48 further comprises oblong shaped apertures 54, 55 which substantially run the length of the U-shaped channel 52. As shown in FIG. 2, the U-shaped channel 52 of the lower mounting bar 48 engages stripping mechanisms 62, which in this embodiment calls for tensioning bolts 56, mounting nuts 58, and washers 60, similar to the system for mounting the fixed stripping heads 34 to the upper portion 4 of the stripping apparatus 2. The lower mounting bar 48 is slidably engaged with U-shaped lower mounting bracket 44 and slidably engaged with the broadhead stripping mechanisms 62 allowing infinite adjustment along the U-shaped lower mounting bar of each.

The lower portion 6 of the stripping apparatus 2 is configured to hold a variety of stripping mechanisms. As shown in FIG. 1, the lower portion 6 of the stripping apparatus 2 has been outfitted with two types of broadhead stripping mechanisms 62 and a stripping pin mechanism 54.

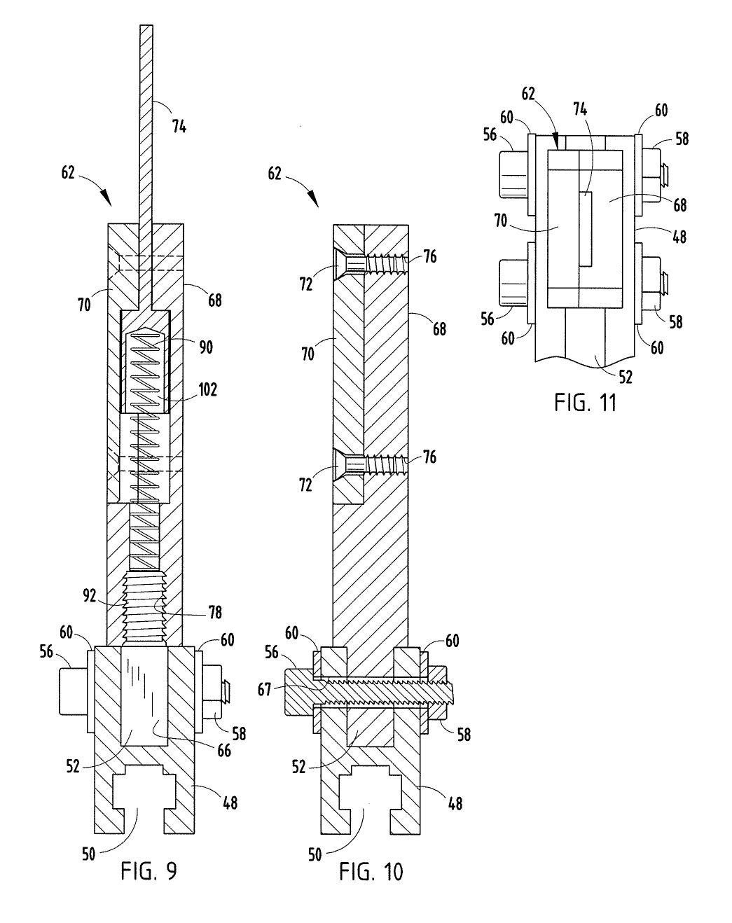

Applicants have surprisingly and unexpectedly found that using a broadhead stripping blade or head allows for increased accuracy in ejecting waste material and also solves the clogging problems and variability problems of stripping pin groupings. As shown in the embodiment in FIG. 2, the broadhead stripping mechanism 62 has a broad stripping head or blade 74 wherein the stripping surface 100 (FIG. 5C) of the stripping head or blade 74 is generally linear in configuration and has a broadhead with a width in extent from one side to the other side of the stripping surface 100 that is wider than a stripping pin 64 as shown in FIG. 1. The broadhead stripping mechanism 62 shown in the embodiment in FIG. 2 is mounted to the lower mounting bar 48. The broadhead stripping mechanism 62 comprises one or more mounting flanges 66, a stripping head housing 68 further comprising a housing cover 70 secured to the striping head housing 68 by bolts 72, and a retractable striping head 74. As shown in FIG. 3, the mounting flanges 66 are adapted to fit into the U-shaped channel 52 of the lower mounting bar 48. The mounting flanges 66 further comprise apertures 67 which allow for tensioning bolts 56 to thread through the mounting flanges 66. In this embodiment, the stripping head housing 68 of the broadhead striping mechanism 62 comprises four threaded apertures 76 which engage bolts 72 to hold the housing cover 70 firmly affixed to the stripping head housing 68. The stripping head housing 68 further comprises a vertical circular threaded channel 78 which extends through the stripping head housing 68 and terminates between the mounting flanges 66. The vertical threaded channel opens up into a housing cavity 80 created by the striping head housing 68 and the housing cover 70. The housing cavity 80 comprises a deep portion 82 and a shallow portion 84. In use, the stripping head 74 is placed at least partially within the housing cavity 80 created by the stripping head housing 68 and the housing cover 70. The stripping head 74 comprises a body portion 86 and a catch portion 88. The catch portion 88 of the stripping head 74 is designed to fit within the deep portion 82 of the housing cavity 80. The body portion 86 of the stripping head 74 is adjacent to the shallow portion 84 of the housing cavity 80. In operation, the stripping head 74 is slidably engaged with the housing cavity 80 when the housing cover 70 is affixed to the stripping head housing 68. The stripping head 74 is biased vertically upward by a spring 90 which is also disposed within the housing cavity 80. The spring 90 is at least partially disposed within the vertical threaded channel 78 and extends at least partially into the housing cavity 80 of the broadhead stripping mechanism 62 and further into a cavity 102 of the stripping head 74 (FIG. 9). The vertical threaded channel 78 engages a threaded cylinder 92 which can be threaded any distance along the threaded vertical channel 78 such that as the threaded cylinder 92 moves vertically upward, the spring 90 moves upwards as well biasing the stripping head to an extended position as shown in FIG. 2. The spring 90 abuts the back end of the catch portion 88 in cavity 102 of the stripping head 74. When the stripping head 74 is fully extended, the catch 88 portion of the stripping head 74 abuts the shallow portion 84 of the housing cavity 80 created by the stripping head housing 68 and the housing cover 70. When the broadhead stripping mechanism 62 is fully assembled, the stripping head 74 can be plunged at least partially into the housing cavity 80 in a retracted position and then sprung back into its resting extended position by the force produced by spring 90.

As shown in FIGS. 5A-5C, the stripping head 74 can have a variety of broadhead configurations at the point at which it contacts the paperboard sheet, or the stripping surface as discussed below. The fixed stripping heads 34 and retractable stripping heads 74 (or blades) are interchangeable such that various profiles of the retractable stripping head 74 and corresponding fixed stripping head 34 can be used to more closely resemble the waste area to be removed.

FIG. 5A shows the stripping head 74 with a broad stripping surface 94 having an apex 96 disposed in the middle of the broad stripping surface 94. Such a configuration, as shown in FIG. 5A, can be used for, among other things, releasing the waste paper which is cut from a paperboard sheet when a hanger hole is desired in the final paperboard packaging. As shown in FIG. 5B, the stripping head 74 has a broad stripping surface 98, which is broader than the body portion 86 of the stripping head 74. As shown in FIG. 5C, the stripping head 74 has a stripping surface 100 which has the same width as the body portion 86 of the stripping head 74.

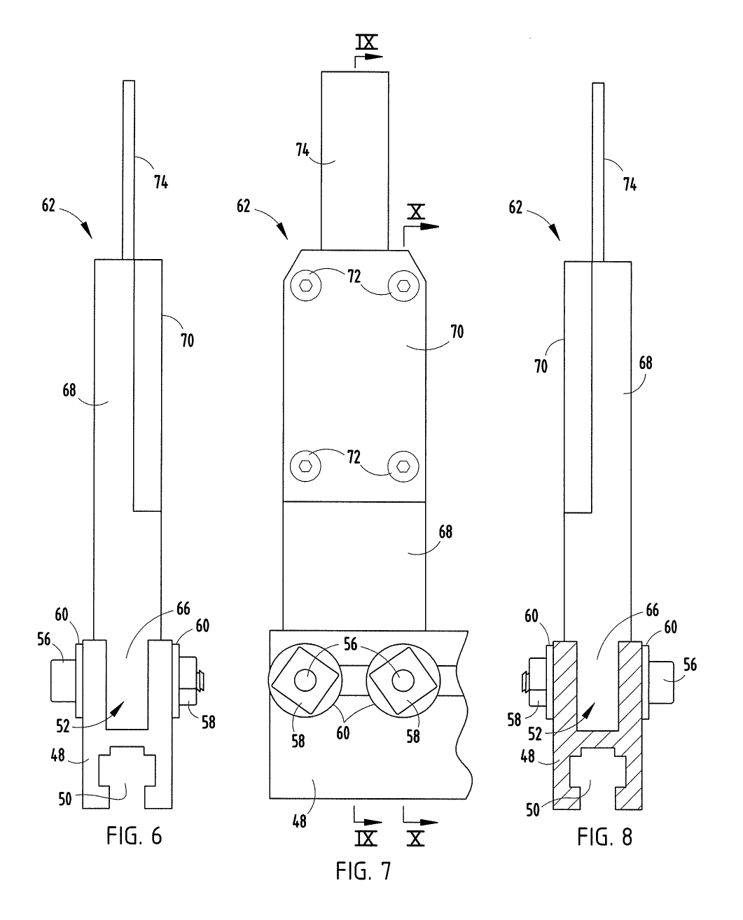

In the embodiments shown in FIGS. 6, 7, and 8 show the broadhead stripping mechanism 62 engaged with the lower mounting bar 48.

In the embodiment shown in FIG. 9, the stripping head 74 further comprises a cavity 102 disposed within the catch portion 88 of the stripping head 74. The cavity 102 is designed to engage the spring 90 and hold it in place during the functioning of the stripping apparatus 2.

In the embodiments shown in FIG. 10, the bolts 72 that hold the housing cover 70 to the stripping head housing 68 are shown threaded into the stripping head housing 68. As shown in FIG. 11, the tensioning bolts 56 hold the broadhead stripping mechanism 62 in place in the lower mounting bar 48, disposed within the U-shaped channel 52.

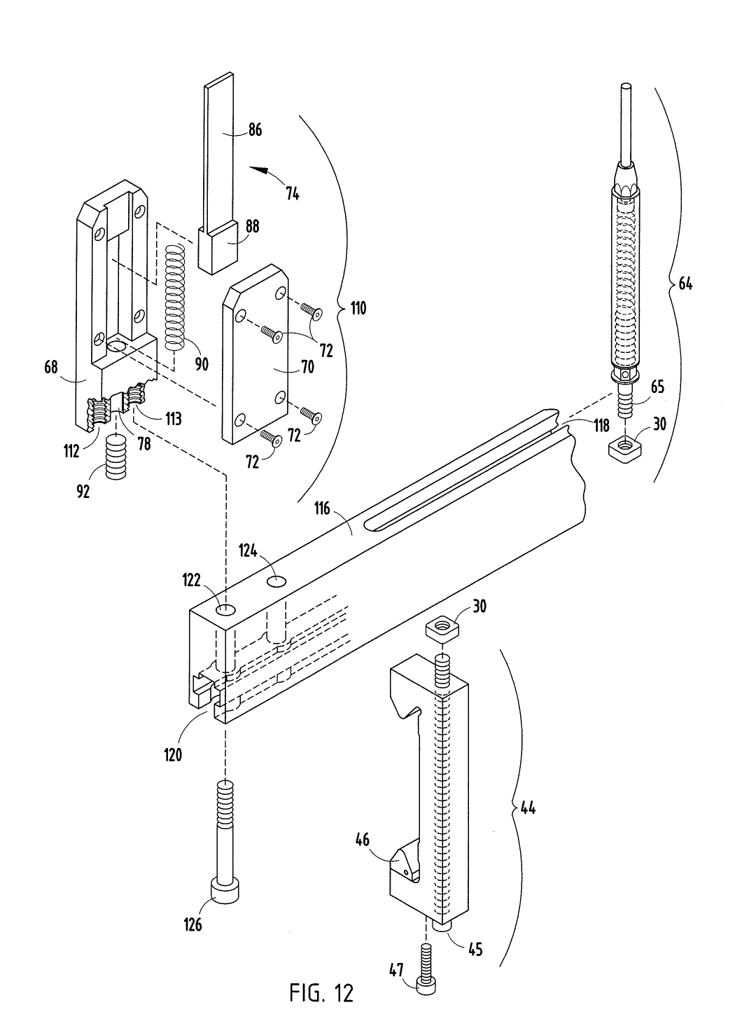

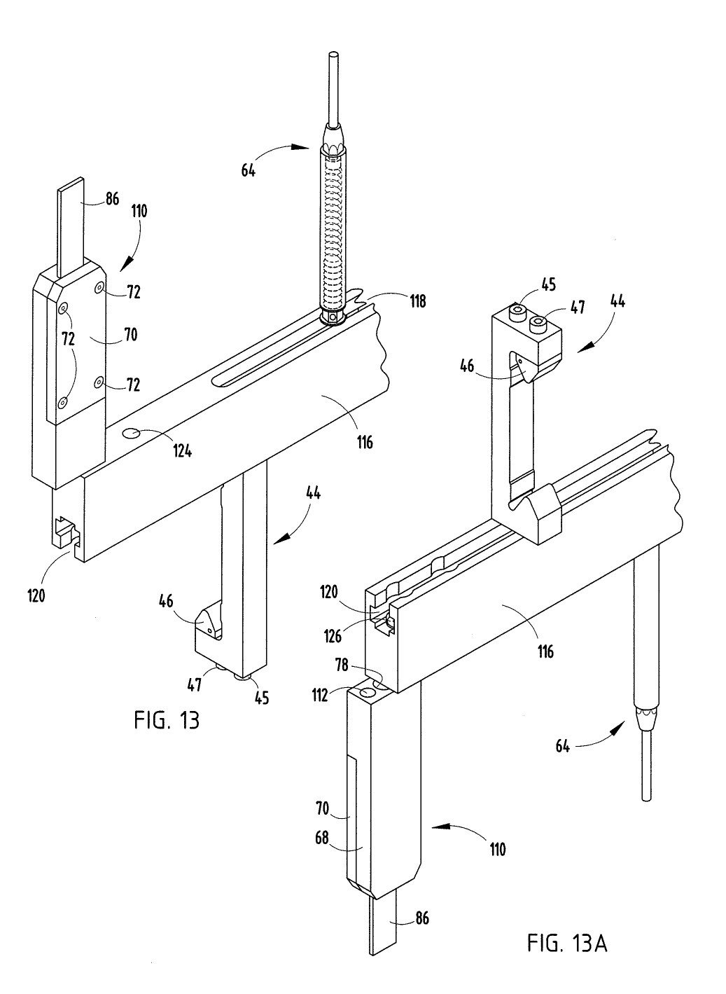

In the embodiment shown in FIG. 12, a broadhead stripping mechanism 110 has a stripping head housing 68 and housing cover 70 much like the broadhead stripping mechanism 62. In the embodiment shown in FIG. 12, the broadhead stripping apparatus 110 further comprises threaded mounting apertures 112, 113 adjacent on either side of the vertical threaded channel 78 (see also FIGS. 13A and 19).

In the embodiment shown in FIG. 12, a lower mounting bar 116 has both an upper inverted T-shaped channel 118 and a lower T-shaped channel 120. In this embodiment, the lower T-shaped channel 120 runs the length of the lower mounting bar 116 and the upper inverted T-shaped channel 118 runs substantially the length of the lower mounting bar 116. The lower mounting bar 116 further comprises mounting apertures 122, 124 that can be lined up with the threaded mounting apertures 112, 113 of the broadhead stripping mechanism 110.

The mounting apertures 122, 124 extend vertically through the length of the lower mounting bar 116, such that they are accessible within the lower T-shaped channel 120 of the mounting bar 116. The mounting apertures 122, 124 make for a fixed position for a broadhead stripping apparatus 110 for use in a job where infinite adjustability of the broadhead stripping apparatus 110 is not required. The lower mounting bar 116, having the lower T-shaped channel 120, is again configured to accept a U-shaped lower mounting bracket 44 which engages the lower T-shaped channel 120 in a similar manner as the U-shaped lower mounting bracket 44 shown in FIG. 1 for slidable engagement of a die press (not shown). The embodiment in FIG. 12 can also engage a stripping pin mechanism 64 which has a threaded end 65 which can engage the mounting block 30 within the U-shaped channel 118 to secure and hold the stripping pin mechanism 64 in the lower mounting bar 116.

As shown in FIGS. 13 and 13A, the broadhead stripping mechanism 110 can be mounted to the lower mounting bar 116 using only one of the mounting apertures 122 or 124. Thus, the broadhead stripping mechanism 110 can be moved from the mounting aperture 122 alone, to both mounting apertures 122, 124, or to the mounting aperture 124 alone. Thus, the broadhead stripping mechanism 110 can be moved to a variety of fixed positions along the mounting bar 116 to allow for adjustment for a particular job.

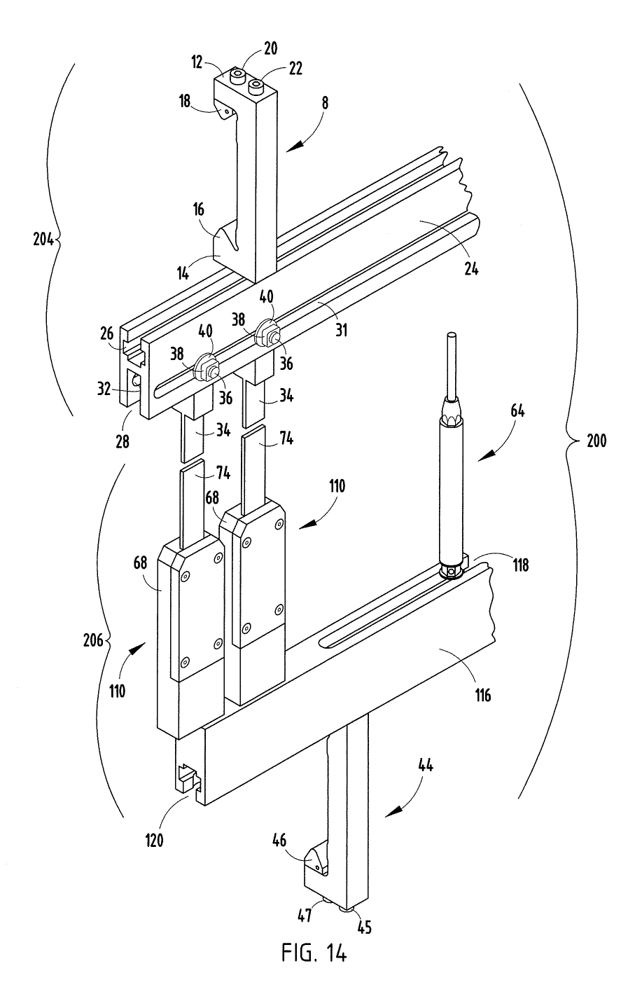

In the embodiment shown in FIG. 14, a stripping apparatus 200 comprises two broadhead stripping mechanisms 110 mounted to the lower mounting bar 116 each using one mounting aperture 122, 124, respectively. In the embodiment shown in FIG. 14, the upper portion 204 of the stripping apparatus 200 is shown to have fixed the stripping heads 34 mounted to the upper mounting bar 24 which are aligned with the broadhead stripping mechanisms 110 of the lower portion 206. Thus, in operation, the upper portion 204 of the stripping apparatus 200 will be pressed down in the die press towards the lower portion 206 of the stripping apparatus 200 such that the fixed stripping heads 34 will pinch a paperboard sheet (not shown) against the broad stripping surface 94 of the stripping heads 74 of the broadhead stripping mechanisms 110 at a point in a paperboard sheet where there is waste material that is to be removed. Thus, the fixed stripping heads 34 of the upper portion 204 of the stripping apparatus 200 will pinch the waste material of the paperboard sheets against the stripping heads 74 and then depress the stripping heads 74 to a retracted position at least partially disposed within the stripping head housings 68 of the broadhead stripping mechanisms 110. Thus, the waste material will be pinched and discharged from the paperboard sheet and as the upper portion 204 retracts, the stripping heads 74 will be brought back to their extended positions by the springs 90 disposed within the stripping head housings 68. In the embodiment shown in FIG. 14, the stripping pin 64 would also align with a fixed stripping head (not shown) having the same shape as the stripping pin 64, and pinch waste material from the paperboard sheet.

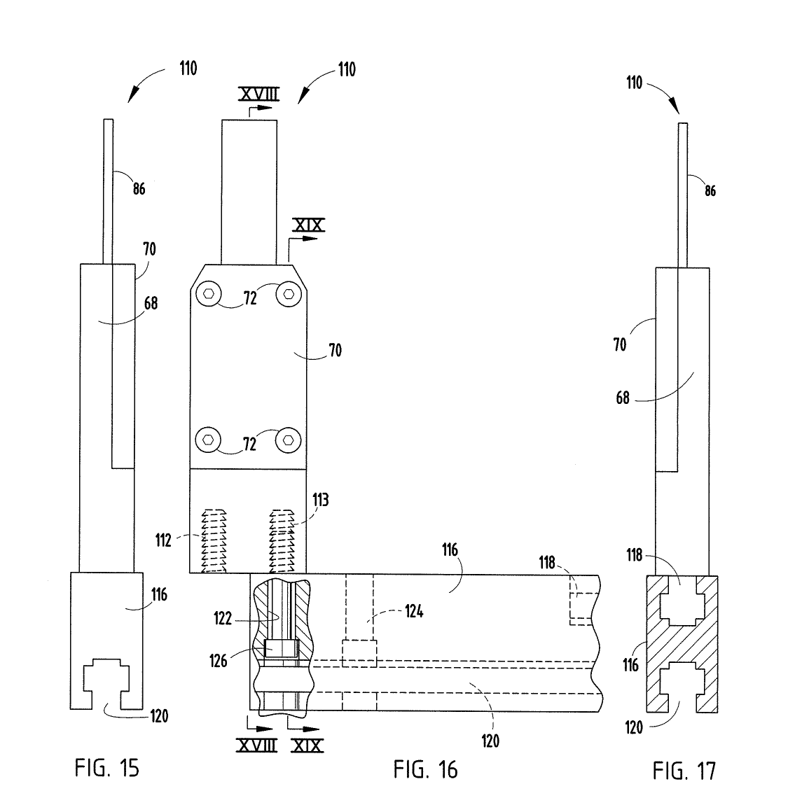

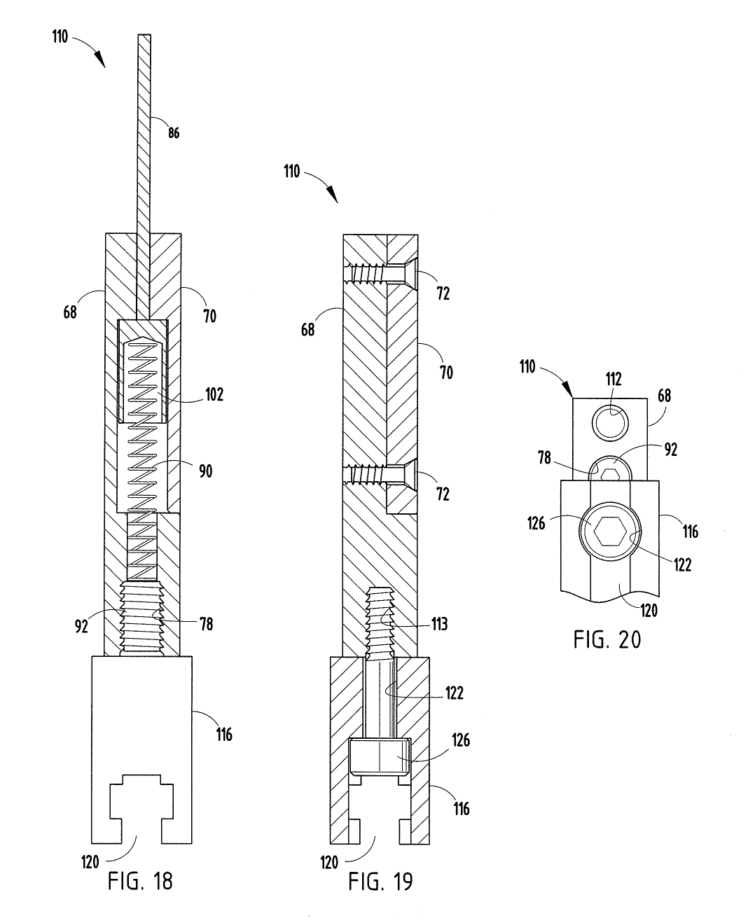

As shown in the embodiments of FIGS. 15, 16, and 17, the broadhead stripping mechanism 110 is mounted to the lower mounting bar 116 through mounting apertures 122, 124 (not shown). FIG. 18 shows a broadhead stripping mechanism 110 mounted to the lower mounting bar 116. FIG. 19 shows a broadhead stripping mechanism 110 mounted to the lower mounting bar 116 using a mounting bolt 126 through the aperture 122 as threaded into the threaded mounting aperture 113 of the broadhead stripping mechanism 110. FIG. 20 shows the same broadhead stripping mechanism 110 mounted to the lower mounting bar 116 using the mounting bolt 126 through the aperture 122 threading into the threaded mounting aperture 113 of the broadhead stripping mechanism 110.

It is noted that the stripping apparatuses 2, 200 as shown in FIGS. 1 and 14 are designed to have a variety of customizable dedicated layouts of broadhead stripping mechanisms 62, 110 to coincide with fixed stripping heads 34 having substantially similar stripping surfaces as the blades used in broadhead stripping mechanism 62, 100 for use in creating customizable stripping applications as needed for each job. The adjustability of the stripping apparatuses 2, 200 for making dedicated layouts allows for increased efficiency for jobs requiring repeatability of a dedicated layout.

The above description is considered of preferred embodiments only. Modifications of the invention will occur to those skilled in the art and to those who make or use the invention. Therefore, it is understood that the embodiments shown in the drawings and described above are merely for illustrative purposes and not intended to limit the scope of the invention.

We claim:

1. A broadhead stripping mechanism comprising:
a housing;
a housing cover operably coupled to the housing wherein at least a portion of the housing and housing cover define a housing cavity having a deep portion and shallow portion;
a stripping blade operably coupled to the housing and configured to be at least partially retractably received within the housing cavity such that the stripping blade has a retracted position and an extended position wherein the stripping blade retracts at least partially into the housing cavity when in the retracted position, the stripping blade further comprising;
a first end;
a second end; and
a body portion wherein the first end comprises a catch which abuts the shallow portion of the housing cavity when the stripping blade is in the extended position and the second end comprises a stripping surface; and
a biasing mechanism operably connected to the stripping blade and configured to bias the stripping blade towards the extended position.

2. The broadhead stripping mechanism of claim 1, wherein the stripping blade is slidably coupled to the housing.

3. The broadhead stripping mechanism of claim 1, wherein the stripping blade is replaceably coupled to the housing.

4. The broadhead stripping mechanism of claim 1, wherein the stripping blade further comprises:
at least one mounting flange disposed on the housing.

5. The broadhead stripping mechanism of claim 1, wherein the stripping blade further comprises at least one mounting aperture.

6. The broadhead stripping mechanism of claim 5, wherein the at least one mounting aperture is threaded.

7. The broadhead stripping mechanism of claim 1, wherein the stripping surface is at least as wide as the body portion of the stripping blade.

8. The broadhead stripping mechanism of claim 7, wherein the stripping surface is configured to strip the shape of a hanger hole.

9. A stripping apparatus comprising:
an upper portion and a lower portion mutually opposed in relation, wherein
the upper portion comprises:
a mounting bracket,
a mounting bar operably coupled to the at least one mounting bracket, and
at least one fixed broadhead stripping head operably coupled to the mounting bar, and
the lower portion comprises:
a mounting bracket,
a mounting bar operably coupled to the at least one mounting bracket, and
at least one broadhead stripping mechanism operably coupled to the mounting bar further comprising a broadhead stripping blade.

10. The stripping apparatus of claim 9, wherein the mounting bar of the upper portion further comprises first and second channels.

11. The stripping apparatus of claim 10, wherein the first channel of the mounting bar of the upper portion further comprises an upward facing channel configured to slidably receive the mounting bracket of the upper portion along the upward facing channel.

12. The stripping apparatus of claim 10, wherein the second channel of the mounting bar of the upper portion further comprises an downward facing channel configured to slidably receive the at least one fixed broadhead stripping head along the downward facing channel.

13. The stripping apparatus of claim 9, wherein the mounting bar of the lower portion further comprises first and second channels.

14. The stripping apparatus of claim 13, wherein the first channel of the mounting bar of the lower portion further comprises an upward facing channel configured to slidably receive the at least one retractable broadhead stripping mechanism along the upward facing channel.

15. The stripping apparatus of claim 13, wherein the second channel of the mounting bar of the lower portion further comprises a downward facing channel configured to slidably receive the mounting bracket of the lower portion along the downward facing channel.

16. The stripping apparatus of claim 9, wherein the mounting bar of the upper portion further comprises at least one mounting aperture.

17. The stripping apparatus of claim 16, wherein the at least one fixed broadhead stripping head of the upper portion further comprises at least one mounting aperture.

18. The stripping apparatus of claim 9, wherein the mounting bar of the lower portion further comprises at least one mounting aperture.

19. The stripping apparatus of claim 18, wherein the at least one broadhead stripping mechanism of the upper portion further comprises at least one mounting aperture.

20. A method of making a stripping apparatus comprising the steps of:
providing a first mounting bracket;
providing a first mounting bar adapted to slidably receive the first mounting bracket;
coupling the first mounting bar to at least one fixed broadhead stripping head;
providing a second mounting bracket;
providing a second mounting bar adapted to slidably receive the second mounting bracket; and
coupling the second mounting bar to at least one broadhead stripping mechanism.
